(19) United States
(12) Patent Application Publication
(10) Pub. No.: US 2026/0074094 A1
(43) Pub. Date: Mar. 12, 2026

(54) BUSWAY ASSEMBLY, BUSWAY CONNECTOR AND PARTITION PLATE THEREOF

(71) Applicant: Schneider Electric Industries SAS, Rueil Malmaison (FR)

(72) Inventors: Tianjin XIAO, Guangzhou (CN); Xianfeng Song, Guangzhou (CN); Jianyuan Huang, Guangzhou (CN); Lieyan Bai, Guangzhou (CN)

(21) Appl. No.: 19/323,330

(22) Filed: Sep. 9, 2025

(30) Foreign Application Priority Data
Sep. 9, 2024 (CN) 202422205432.8

(51) Int. Cl. H01B 17/16; H01B 17/18; H01R 9/22; H02B 1/20; H02G 5/00

(52) U.S. Cl. CPC H01B 17/16; H01B 17/18; H01R 9/226; H02B 1/20; H02G 5/007

(57) ABSTRACT

Embodiments of the present disclosure provides a busway assembly, a busway connector and a partition plate thereof. The partition plate of the busway connector includes: a separator body including a first surface and a second surface that are opposite to each other; at least one conducting member mounted in the separator body; a first conductor fixed on the first surface; and a second conductor fixed on the second surface and electrically connected to the first conductor through the at least one conducting member.

### CROSS-REFERENCE

This application claims priority to Chinese Patent Application No. 202422205432.8, filed on Sep. 9, 2024, and entitled “BUSWAY ASSEMBLY, BUSWAY CONNECTOR AND PARTITION PLATE THEREOF”, the entirety of which is incorporated herein by reference.

### FIELD

Embodiments of the present disclosure generally relate to a busway assembly, a busway connector and a partition plate thereof.

### BACKGROUND

A busway is a current transmission device, and is widely used in electrical equipment or power systems of civil buildings, factories or the like. Two busways and a busway connector connected therebetween may be collectively referred to as a busway assembly.

The busway assembly is mainly used in an AC (alternating current) application scenario. For a busway with four phase lines (the four phase lines may be referred to as an A phase line, a B phase line, a C phase line, and an N phase line), the four phase lines are insulated from each other. When the busway is applied to a DC (direct current) application scenario, it is necessary to connect the A phase line and the B phase line of the busway in parallel to form a phase line to serve as a positive phase line, and connect the C phase line and the N phase line in parallel to form a phase line to serve as a negative phase line.

In the related art, special flanges are disposed at two ends of a circuit composed of a plurality of busway assemblies, so that the four phase lines of the busways are connected in parallel in pairs at the special flanges. However, for a circuit with a long current transmission distance, if there is a power tapping device in the middle of the circuit, but only the four phase lines are connected in parallel in pairs to form two phase lines at the two ends of the circuit, differences in temperature rise will occur due to current imbalance, thereby affecting the performance of the busway.

### SUMMARY

In a first aspect of the present disclosure, there is provided a partition plate of a busway connector, including: a separator body including a first surface and a second surface that are opposite to each other; at least one conducting member mounted in the separator body; a first conductor fixed on the first surface; and a second conductor fixed on the second surface and electrically connected to the first conductor through the at least one conducting member.

In some embodiments, the separator body is provided with at least one through hole, and the at least one conducting member is fitted in the at least one through hole.

In some embodiments, the at least one conducting member is integrally formed with the first conductor or the second conductor.

In some embodiments, the separator body is integrally formed with the at least one conducting member through injection molding.

In some embodiments, the separator body is provided with a mounting hole for a fastener to pass through, and the separator body is fitted with two conducting members, and the two conducting members are arranged at an interval along a length direction of the separator body and are located on two opposite sides of the mounting hole.

In some embodiments, the separator body is provided with a mounting hole for a fastener to pass through, and a first sleeve part and a second sleeve part which are arranged around the mounting hole, and the first sleeve part extends outwardly from the first surface, and the second sleeve part extends outwardly from the second surface; and the first conductor has a first connecting hole sleeved on the first sleeve part, and the second conductor has a second connecting hole sleeved on the second sleeve part.

In some embodiments, the first connecting hole and the second connecting hole are both rectangular holes and have the same size; and/or an end face of the first sleeve part is provided with an annular sleeve part for insertion into a sleeve part of a partition plate adjacent to the first surface, and the second sleeve part is for a sleeve part of a partition plate adjacent to the second surface to be inserted therein.

In a second aspect of the present disclosure, there is provided a busway connector, including: two end caps disposed opposite to each other; a plurality of partition plates disposed between the two end caps, at least two of the plurality of partition plates being the partition plate according to a first aspect of the present disclosure; and a fastener assembly securing the two end caps and the plurality of partition plates together.

In some embodiments, the plurality of partition plates include a first partition plate, a second partition plate, a third partition plate, a fourth partition plate, and a fifth partition plate which are sequentially arranged, where the second partition plate and the fourth partition plate adopt the partition plate according to a first aspect of the present disclosure.

In a third aspect of the present disclosure, there is provided a busway assembly, including: two busways; and the busway connector according to a second aspect of the present disclosure, the busway connector being connected between the two busways.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 shows a perspective view of a partition plate of a busway connector according to an embodiment of the present disclosure;

FIG. 2 shows a perspective cross-sectional view taken along section line H-H shown in FIG. 1;

FIG. 3 shows an exploded view of the partition plate shown in FIG. 1.

FIG. 4 shows a perspective view of a busway connector according to an embodiment of the present disclosure;

FIG. 5 shows a cross-sectional view taken along section line D-D shown in FIG. 4;

FIG. 6 shows a partial enlarged view of portion E in FIG. 5;

FIG. 7 shows an exploded view of the busway connector shown in FIG. 4;

FIG. 8 shows a perspective view of a busway assembly according to an embodiment of the present disclosure;

FIG. 9 shows a cross-sectional view taken along section line F-F shown in FIG. 8; and

FIG. 10 shows a partial enlarged view of portion G in FIG. 9.

### DETAILED DESCRIPTION

Embodiments of the present disclosure will be described in more detail below with reference to the accompanying drawings. While Embodiments of the present disclosure are shown in the drawings, it should be understood that the present disclosure may be implemented in various forms and should not be limited by the embodiments set forth herein. Rather, these embodiments are provided to make this disclosure more thorough and complete, and to fully convey the scope of the present disclosure to those skilled in the art.

As used herein, the term “including” and variations thereof represent openness, i.e., “including but not limited to”. Unless specifically stated, the term “or” means “and/or”. The term “based on” means “based at least in part on”. The terms “an example embodiment” and “an embodiment” mean “at least one example embodiment”. The term “another embodiment” means “at least one further embodiment”. The terms “first”, “second”, and the like may refer to different or identical objects.

As described above, the busway assembly is mainly used in an AC application scenario, and the four phase lines of the busway are insulated from each another in the circuit. When the busway assembly is applied to a DC application scenario, it is necessary to connect the four phase lines of the busway in parallel to form two phase lines. The paralleling scheme in the related art will lead to relatively significant differences in temperature rise between different phase lines in the circuit and affect the performance of the busway.

Embodiments of the present disclosure provide a busway assembly 1000, a busway connector 100 and a partition plate 10 thereof. Busways 50 of the busway assembly 1000 are connected to each other through the busway connector 100 provided by embodiments of the present disclosure, and the four phase lines of the busways 50 can be connected in parallel to form two phase lines without adding an additional component, which helps solve the problem of relatively significant differences in temperature rise between different phase lines inside the circuit, thereby helping improve the performance of the busway. Hereinafter, the principles of the present disclosure will be described with reference to FIG. 1 to FIG. 10.

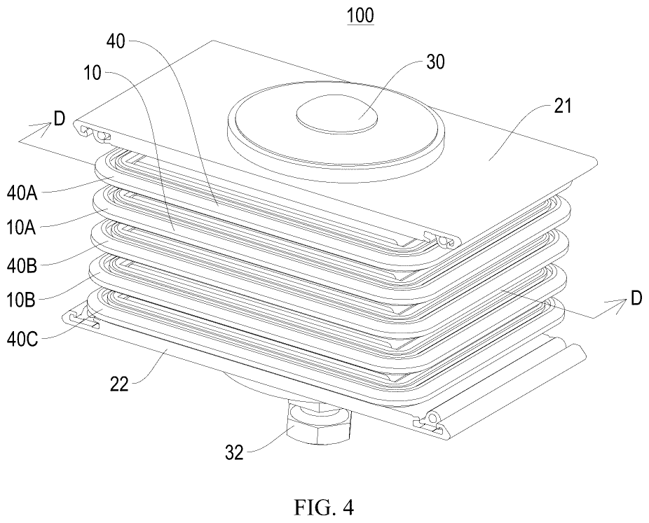

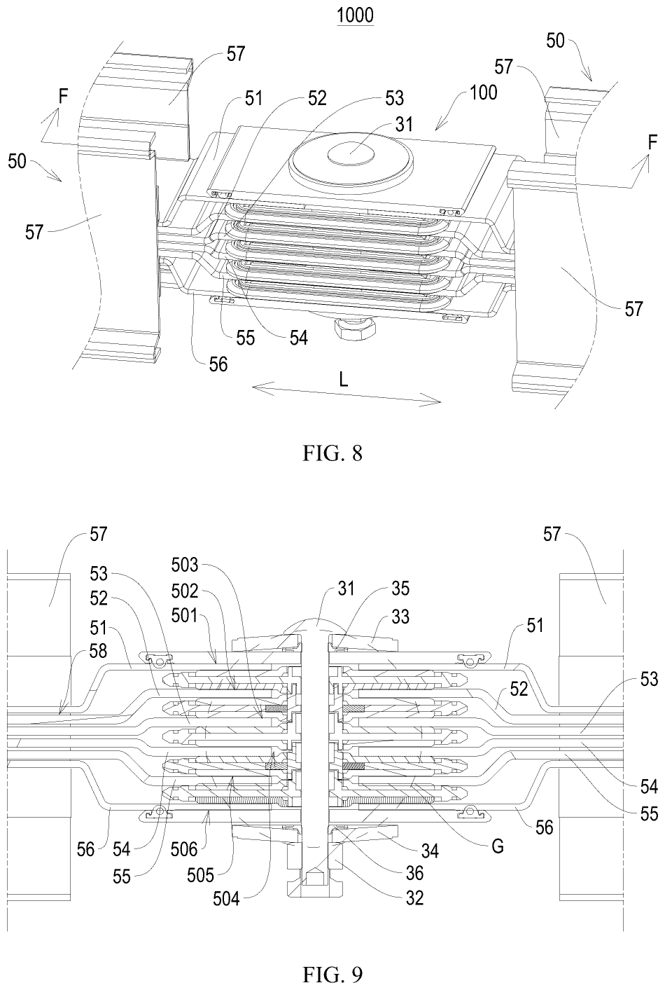

FIGS. 1 to 3 show schematic structural diagrams of the partition plate 10 of the busway connector 100 according to an embodiment of the present disclosure. FIGS. 4 to 7 show schematic structural diagrams of the busway connector 100 according to an embodiment of the present disclosure, which is provided with the partition plate 10 of the busway connector 100 according to an embodiment of the present disclosure. FIGS. 8 to 10 show schematic structural diagrams of the busway assembly 1000 according to an embodiment of the present disclosure, which is provided the busway connector 100 according to an embodiment of the present disclosure.

First, a structure of the partition plate 10 of the busway connector 100 (hereinafter referred to as the partition plate 10 for short) provided according to embodiments of the present disclosure will be described in detail below with reference to FIGS. 1 to 3. The partition plate 10 mainly includes a separator body 11, two conducting members 12, a first conductor 13, and a second conductor 14.

In some embodiments, the separator body 11 is an insulating separator in a flat shape. The separator body 11 includes a first surface 111 and a second surface 112 opposite to each other. In some embodiments, the separator body 11 is made of an insulating material.

The first conductor 13 and the second conductor 14 are respectively in a flat plate-shaped, the first conductor 13 is fixed on the first surface 111 of the separator body 11, and the second conductor 14 is fixed on the second surface 112 of the separator body 11. The first conductor 13 and the second conductor 14 may be made of copper or aluminum. The materials of the first conductor 13 and the second conductor 14 may further have good thermal conductivity.

The first conductor 13 and the second conductor 14 may also be referred to as “bars”, and the first conductor 13 and the second conductor 14 may have different names depending on the materials of the first conductor 13 and the second conductor 14. For example, when the first conductor 13 and the second conductor 14 are made of copper, they may be referred to as “copper bars”. When the first conductor 13 and the second conductor 14 are made of aluminum, they may be referred to as “aluminum bars”. Of course, the materials of the first conductor 13 and the second conductor 14 are not limited to copper and aluminum.

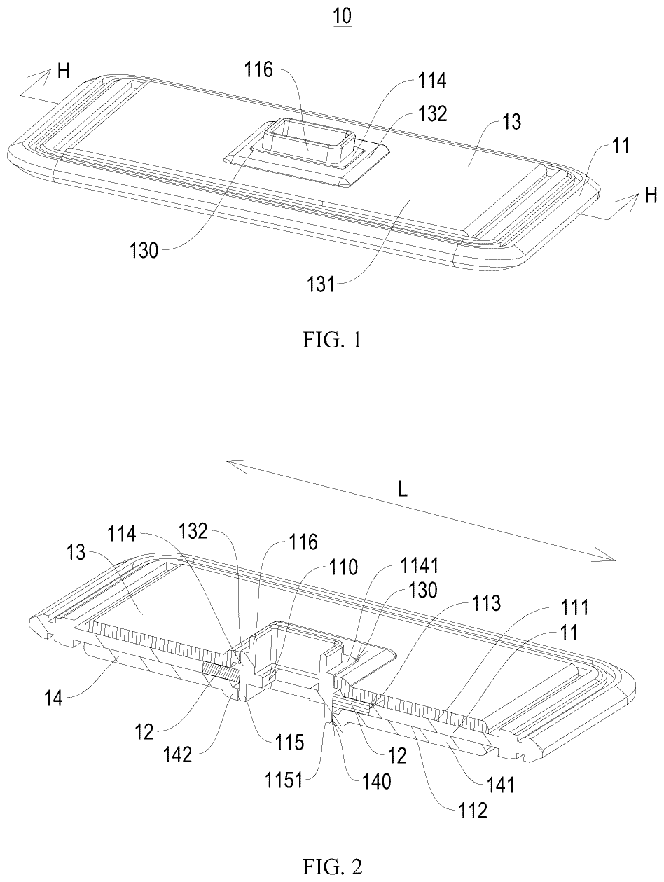

The two conducting members 12 are mounted in the separator body 11. Each of the conducting members 12 may be made of any suitable conductive material. The material of each of the conducting members 12 may have good thermal conductivity. As can be seen in FIG. 2, the first conductor 13 and the second conductor 14 are both in contact with each of the conducting members 12, and the first conductor 13 is electrically connected to the second conductor 14 through each of the conducting members 12.

In some embodiments, the first conductor 13, the second conductor 14, and each of the conducting members 12 may be made of the same material, so as to have substantially the same electrical conductivity and thermal conductivity. Of course, in some alternative embodiments, the materials of the first conductor 13, the second conductor 14, and each of the conducting members 12 may have other implementations. For example, the first conductor 13 and the second conductor 14 are made of the same material, while the first conductor 13 and the conducting members 12 are made of different materials.

For the busway connector applied to the AC application scenario, the separator body 11 of the partition plate of the busway connector in the related art is not provided with a conducting member 12, and the first conductor 13 and the second conductor 14 located on two surfaces of the separator body 11 are insulated from each other. More specifically, the first conductor 13 is in contact with a pair of corresponding phase lines of two busways (taking A phase lines of the two busways as an example), respectively, so as to electrically connect a pair of corresponding A phase lines of the two busways to each other. The second conductor 14 is in contact with another pair of corresponding phase lines of the two busways (taking B phase lines adjacent to the A phase lines as an example), respectively, so as to electrically connect the another pair of corresponding B phase lines of the two busways to each other. The A phase lines of the two busways electrically connected by the first conductor 13 and the B phase lines of the two busways electrically connected by the second conductor 14 are insulated from each other. As mentioned above, when the busway connector is applied to the DC application scenario, by disposing special flanges at two ends of the circuit, the four phase lines of the busways can be connected in parallel in pairs at the two ends of the circuit. However, the A phase line and B phase line of each of the busways in the circuit are insulated from each other, and if there is a power tapping device in the middle of the circuit, it will lead to relatively significant differences in temperature rise between the A phase line and the B phase line due to current imbalance, which will affect the performance of the busway.

When the partition plate 10 provided by embodiments of the present disclosure is applied to the busway connector 100, two adjacent busways 50 can be connected to each other through the busway connector 100 and then may be applied to the DC application scenario. For example, referring to FIG. 9, A phase lines 52 of the two busways 50 are electrically connected to each other through the first conductor 13, and B phase lines 53 of the two busways 50 are electrically connected to each other through the second conductor 14. Meanwhile, the A phase line 52 and the B phase line 53 of each of the busways 50 are electrically connected to each other inside the busway connector 100 through the first conductor 13, the conducting members 12, and the second conductor 14. That is, the A phase lines 52 and the B phase lines 53 are connected in parallel to form a phase line, for example, the phase line serves as a positive phase line. Similarly, a C phase line 54 and an N phase line 55 of each of the busways 50 can be electrically connected to each other by the partition plate 10 with the conducting members 12 therebetween, that is, the C phase line and the N phase line are connected in parallel to form another phase line, for example, the another phase line serves as a negative phase line.

In addition, when the busway connector 100 with the partition plate 10 according to embodiments of the present disclosure is connected to busways 50 and applied to the DC application scenario, the A phase line 52 and the B phase line 53 of each of the busways 50 are electrically connected to each other at the busway connector 100, and the C phase line 54 and the N phase line 55 are also electrically connected to each other at the busway connector 100, which helps balance the temperature rise between the A phase line 52 and the B phase line 53, as well as that between the C phase line 54 and the N phase line 55 in the direct current circuit, thereby helping reduce the differences in temperature rise between different phase lines in the circuit and improving the performance of the busway. In addition, by connecting the four phase lines of the busways 50 in parallel in pairs through the busway connector 100 itself, the parallel connection of the phase lines can be realized without adding other additional components, which helps reduce the cost of the circuit.

It should be noted that, although the busway connector 100 in the above embodiment s is described by taking its connection with the busway 50 with the four phase lines as an example, the present disclosure is not limited thereto. For example, when it is necessary to apply the busways 50 with more than four phase lines to the DC application scenario, the plurality of partition plates in the busway connector 100 can be selectively configured as the partition plate 10 according to embodiments of the present disclosure as required, so as to divide the plurality of phase lines of the busway 50 into two sets of phase lines that are insulated from each other. A plurality of phase lines within each set of phase lines of the busway 50 can be electrically connected to each other through the first conductors 13, the conducting members 12 and the second conductors 14 of the partition plates 10 to form the positive phase line or the negative phase line.

The partition plate 10 of embodiments of the present disclosure is particularly suitable for the bus connector 100 of a dense DC bus circuit.

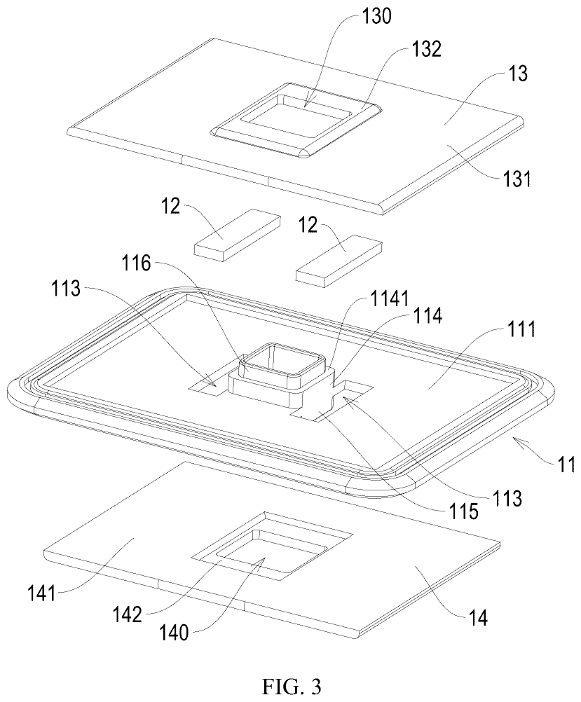

Referring to FIGS. 2 and 3, an illustrative structure of the partition plate 10 is shown. The separator body 11 is provided with through holes 113 corresponding to each of the conducting members 12, and the through holes 113 penetrate through the first surface 111 and the second surface 112 of the separator body 11. Each of the conducting members 12 is fitted in a corresponding through hole 113. When the first conductor 13 and the second conductor 14 are attached to the separator body 11, each of the conducting members 12 is sandwiched between the first conductor 13 and the second conductor 14. The first conductor 13 and the second conductor 14 are respectively in contact with different surfaces of each of the conducting members 12, and then the first conductor 13 is electrically connected to the second conductor 14.

Of course, the conducting members 12 can be mounted in the separator body 11 in other ways. For example, in some embodiments not shown, each of the conducting members 12 may be integrally formed with the first conductor 13 and fitted in the corresponding through hole 113. Alternatively, each of the conducting members 12 may be integrally formed with the second conductor 14 and fitted in the corresponding through hole 113. Alternatively, a part of each of the conducting members 12 is integrally formed with the first conductor 13, the other part of each of the conducting members 12 is integrally formed with the second conductor 14, and each of the conducting members 12 is fitted in the corresponding through hole 113.

In some embodiments not shown, the separator body 11 may be integrally formed with each of the conducting members 12 through injection molding.

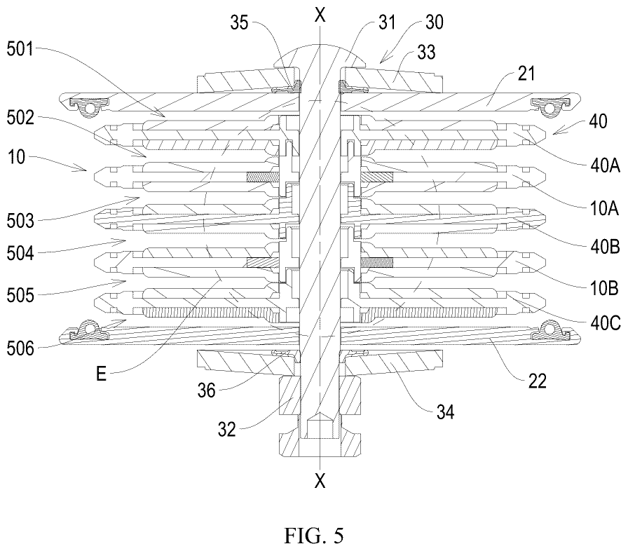

With continued reference to FIGS. 2 and 3, in some embodiments, a mounting hole 110, a first sleeve part 114, and a second sleeve part 115 are disposed in the middle of the separator body 11. The mounting hole 110 is used for a fastener 31 (see FIG. 5, specifically a bolt) of a fastener assembly 30 to pass through. The first sleeve part 114 extends outwardly from the first surface 111 and is arranged around the mounting hole 110. The second sleeve part 115 extends outwardly from the second surface 112 and is arranged around the mounting hole 110. The first conductor 13 has a first connecting hole 130 sleeved on the first sleeve part 114. The second conductor 14 has a second connecting hole 140 sleeved on the second sleeve part 115.

With reference to FIGS. 2 and 8, two ends of the busway connector 100 along its length direction L are respectively connected to the plurality of phase lines of the two busways 50 in an inserting manner. The length direction L of the busway connector 100 is consistent with a length direction L of the partition plate 10. The two conducting members 12 are arranged at an interval along the length direction L of the separator body 11, and the two conducting members 12 are located on two opposite sides of the mounting hole 110. In this way, two to-be-paralleled phase lines of each of the busways 50 may be directly connected in parallel through a corresponding conducting member 12.

It should be noted that although the above embodiments of the present disclosure are described by taking two conducting members 12 as an example, it should be understood that the present disclosure is not limited thereto. In some alternative embodiments, the number, structure, size, arrangement position of the conducting member 12 and its mounting relationship with the separator body 11 may be designed as required, as long as the first conductor 13 and the second conductor 14 can be electrically connected to each other through the conducting member 12, thereby enabling the to-be-paralleled phase lines of the two busways connected to the busway connector 100 to be paralleled.

Referring to FIG. 3, in some embodiments, both the first connecting hole 130 and the second connecting hole 140 are rectangular holes. Correspondingly, a shape of an outer peripheral contour of the first sleeve part 114 is matched with a shape of the first connecting hole 130, and a shape of an outer peripheral contour of the second sleeve part 115 is matched with a shape of the second connecting hole 140. In this way, the first conductor 13, the separator body 11, and the second conductor 14 can be connected together such that they cannot rotate relative to each other.

In some embodiments, the first connecting hole 130 and the second connecting hole 140 have the same size. More specifically, the first conductor 13 and the second conductor 14 have the same structure. In this way, when the first conductor 13 and the second conductor 14 are connected to the separator body 11, there is no need to distinguish whether each of them is matched with the first surface 111 or the second surface 112, instead, each of them can be arbitrarily mounted on the first surface 111 or the second surface 112, thereby helping improve the mounting versatility of the first conductor 13 and the second conductor 14.

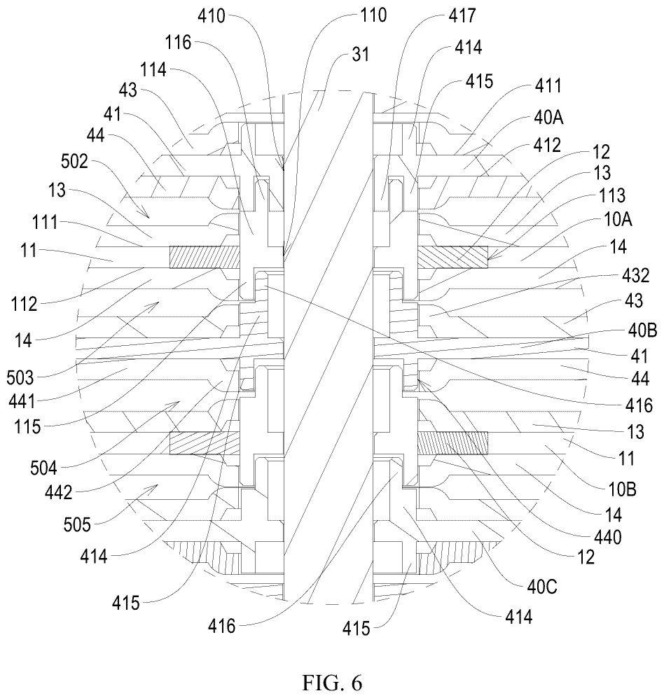

Referring to FIGS. 2 and 6, in some embodiments, a size of an inner hole of the first sleeve part 114 is greater than a size of the mounting hole 110, and a size of an inner hole of the second sleeve part 115 is greater than the size of the inner hole of the first sleeve part 114.

FIGS. 4 to 7 show an illustrative structure of the busway connector 100. The busway connector 100 is provided with partition plates 10 according to the above embodiments of the present disclosure.

Specifically, the busway connector 100 includes an end cap 21 and an end cap 22 disposed opposite to each other, a plurality of partition plates, and the fastener assembly 30. The plurality of partition plates, for example, include a plurality of partition plates 10 and a plurality of partition plates 40. For the structure of the partition plates 10, reference can be made to the above description, and the first conductors 13 and the second conductors 14 on their separator bodies 11 are electrically connected to each other through the conducting members 12. The structure of the partition plates 40 are different from that of the partition plates 10, and the main difference therebetween is that each of the partition plates 40 is not provided with a conducting member.

The plurality of partition plates 10 and the plurality of partition plates 40 are disposed between the end cap 21 and the end cap 22, the fastener assembly 30 secures the end cap 21, the end cap 22, the plurality of partition plates 10, and the plurality of partition plates 40 together.

Specifically, the busway connector 100 shown in FIGS. 4 to 7 is used for connecting the busway 50 with four phase lines. The plurality of partition plates 40 specifically include a partition plate (also referred to as a first partition plate) 40A, a partition plate (also referred to as a third partition plate) 40B, and a partition plate (also referred to as a fifth partition plate) 40C. The plurality of partition plates 10 specifically include a partition plate (also referred to as a second partition plate) 10A and a partition plate (also referred to as a fourth partition plate) 10B. The partition plate 40A, the partition plate 10A, the partition plate 40B, the partition plate 10B, and the partition plate 40C are sequentially stacked between the end cap 21 and the end cap 22 along an axial direction X-X of the fastener 31. It should be noted that the application scope of the partition plate 10 provided by embodiments of the present disclosure is not limited to the busway connector 100 for connecting the busway 50 with the four phase lines.

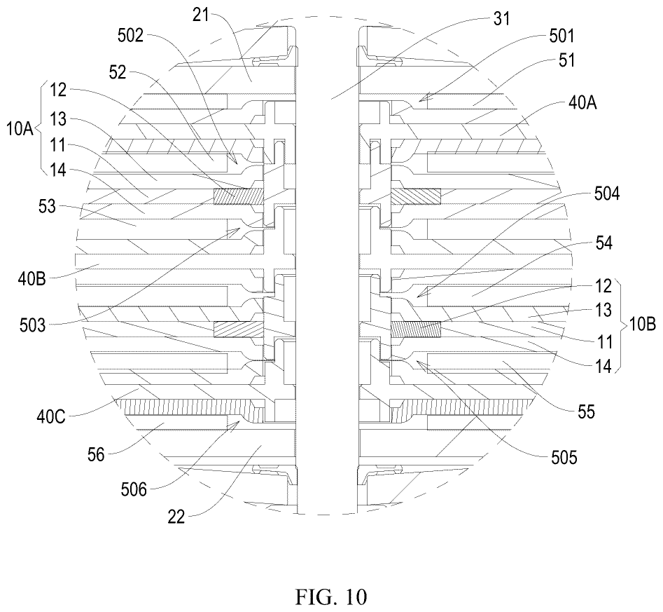

Referring to FIGS. 5 and 10, a space 501 is formed between the end cap 21 and the partition plate 40A for insertion of a cover plate 51 of the busway 50. A space 502 is formed between partition plate 40A and partition plate 10A for insertion of the A phase line 52 of busway 50. A space 503 is formed between the partition plate 10A and the partition plate 40B for insertion of the B phase line 53 of the busway 50. A space 504 is formed between the partition plate 40B and the partition plate 10B for insertion of the C phase line 54 of the busway 50. A space 505 is formed between the partition plate 10B and the partition plate 40C for insertion of the N phase line 55 of the busway 50. A space 506 is formed between the partition plate 40C and the end cap 22 for insertion of a cover plate 56 of the busway 50.

Referring to FIG. 6, each of the partition plates 40 (partition plates 40A, 40B, and 40C) includes a separator body 41, a first conductor 43, and a second conductor 44. The separator body 41 has a mounting hole 410 for the fastener 31 to pass through. The first conductor 43 and the second conductor 44 are mounted on a first surface 411 and a second surface 412 of the separator body 41 that are opposite to each other, and the first conductor 43 and the second conductor 44 are insulated from each other.

The separator body 41 can further include a first sleeve part 414 and a second sleeve part 415. The first sleeve part 414 extends outwardly from the first surface 411 of the separator body 41, and the first sleeve part 414 is arranged around the mounting hole 410. The second sleeve part 415 extends outwardly from the second surface 412 of the separator body 41, and the second sleeve part 415 is arranged around the mounting hole 410. The first conductor 43 has a first connecting hole 430 sleeved on the first sleeve part 414. The second conductor 44 has a second connecting hole 440 sleeved on the second sleeve part 415.

Where there is no conflict, A structure of the first sleeve part 414 may refer to a structure of the first sleeve part 114, and a structure of the second sleeve part 415 may refer to a structure of the second sleeve part 115.

Referring to FIGS. 3 and 6, in some embodiments, an end face 1141 of the first sleeve part 114 of the partition plate 10 is provided with an annular sleeve part 116 for insert ion into a sleeve part of a partition plate adjacent to the first surface 111. Taking the partition plate 10A as an example, the annular sleeve part 116 is inserted into the second sleeve part 415 of the partition plate 40A.

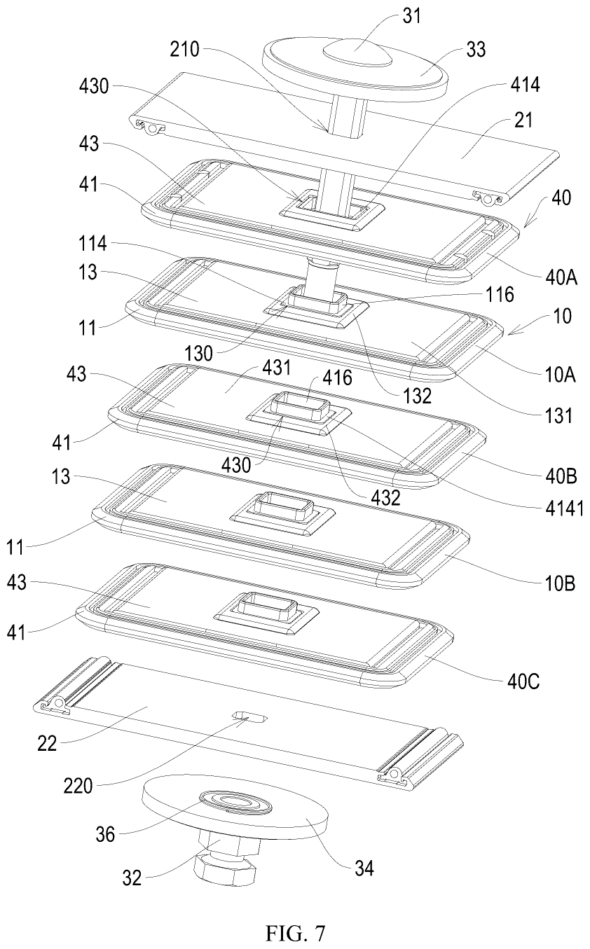

Referring to FIGS. 6 and 7, in some embodiments, an end face 4141 of the first sleeve part 414 of the partition plate 40 is provided with an annular sleeve part 416 for insertion into a sleeve part of a partition plate adjacent to the first surface 411. Taking the partition plate 40B as an example, the annular sleeve part 416 is inserted into the second sleeve part 115 of the partition plate 10A.

Thus, the plurality of partition plates are reliably stacked between the end cap 21 and the end cap 22 through the sleeve parts that are plugged into each other.

It should be noted that the structures of the partition plates 40 may not be exactly the same. For example, each of the partition plates 40 can be selectively provided with the annular sleeve part 416 as required. For example, in the example shown in FIG. 6, the first sleeve part 414 of the partition plate 40A is not provided with the sleeve part 416. In addition, a sleeve part 417 may be disposed inside the second sleeve part 415 of the partition plate 40A, an inner hole of the sleeve part 417 is matched with the fastener 31, and a groove for accommodating the annular sleeve part 116 is formed between the sleeve part 417 and the second sleeve part 415.

Referring to FIGS. 5 and 7, the fastener assembly 30 includes the fastener 31, a nut 32, a washer 33, a washer 34, a sealing ring 35, and a sealing ring 36. The end cap 21 has a mounting hole 210 and the end cap 22 has a mounting hole 220. The fastener 31 passes through the washer 33, the sealing ring 35, the mounting hole 210 of the end cap 21, the mounting holes of each of the partition plates (the mounting holes 110 and the mounting holes 410), the mounting hole 220 of the end cap 22, the sealing ring 36, the washer 34 in sequence and then is connected with the nut 32, thereby fixing components of the busway connector 100 together. Each of the sleeve parts of each of the partition plates (such as the aforementioned first sleeve part or the second sleeve part) is abutted against an adjacent component to define the aforementioned spaces 501-506 between the end cap 21, the plurality of partition plates, and the end cap 22.

In some embodiments, the fastener 31 has a rectangular segment. The mounting hole 210, the mounting holes (the mounting holes 410 and the mounting holes 110) of the plurality of partition plates, and the mounting hole 220 are rectangular holes, respectively. The rectangular segment of the fasteners 31 passes through these rectangular holes, so that relative rotation between the end cap 21, each of the partition plates, and the end cap 22 can be avoided.

Referring again to FIGS. 2 and 3, in some embodiments, the first conductor 13 includes a first main body 131 attached to the first surface 111 and a first annular supporting part 132 protruding from the first main body 131 in a direction away from the first surface 111, and the first annular supporting part 132 defines the first connecting hole 130. An end face of the first annular supporting part 132 is close to the end face 1141 of the first sleeve part 114. The second conductor 14 includes a second main body 141 attached to the second surface 112 and a second annular supporting part 142 protruding from the second main body 141 in a direction away from the second surface 112, and the second annular supporting part 142 defines the second connecting hole 140. An end face of the second annular supporting part 142 is close to an end face 1151 of the second sleeve part 115.

Referring again to FIGS. 6 and 7, in some embodiments, the first conductor 43 includes a first main body 431 attached to the first surface 411 and a first annular supporting part 432 protruding from the first main body 431 in a direction away from the first surface 411, and the first annular supporting part 432 defines the first connecting hole 430. An end face of the first annular supporting part 432 is close to the end face 4141 of the first sleeve part 414. The second conductor 44 includes a second main body 441 attached to the second surface 412 and a second annular supporting part 442 protruding from the second main body 441 in a direction away from the second surface 412, and the second annular supporting part 442 defines the second connecting hole 440. An end face of the second annular supporting part 442 is close to an end face of the second sleeve part 415.

When the fastener 31 is tightened, the annular supporting parts (for example, the aforementioned first annular supporting part and the second annular supporting parts) on each of the partition plates abut against the adjacent components, in combination with the abutment of each sleeve part of each partition plate against adjacent components as described above, and the aforementioned spaces 501-506 are reliably defined between the end cap 21, the plurality of partition plates, and the end cap 22.

In embodiments of the present disclosure, the first conductor on the first surface of the separator body of the busway connector is electrically connected to the second conductor on the second surface through the conducting member, whereby different phase lines of the busway can be connected in parallel inside the busway connector by means of the partition plate, so that the busway can be applied to a DC application environment by means of the busway connector. In addition, different phase lines connected in parallel through the partition plate conduct heat while conducting electricity, temperatures between different phase lines are relatively balanced, thereby helping improve the performance of the busway. In addition, the parallel connection of the different phase lines of the busway can be realized without adding other components besides the busway connector, which helps reduce the cost of the circuit.

FIGS. 8 to 10 show schematic structural diagrams of the busway assembly 1000 according to an embodiment of the present disclosure, which has the busway connector 100 according to embodiments of the present disclosure. The busway assembly 1000 includes two busways 50 and the busway connector 100 connected between the two busways 50.

As described above, the busway 50 of the busway assembly 1000 of the present disclosure specifically takes the busways 50 with four phase lines as an example, although the present disclosure is not limited thereto. In some alternative examples, the busway 50 may have more phase lines.

Referring to FIGS. 8 and 9, a housing of the busway 50 includes two side plates 57 opposite to each other, the cover plate 51 and the cover plate 56 connected between the two side plates 57. The cover plate 51 and the cover plate 56 are disposed opposite to each other, and together with the two side plates 57, define a receiving cavity 58. A plurality of phase lines of the busways 50 passes through the receiving cavity 58, and the plurality of phase lines specifically include an A phase line 52, a B phase line 53, a C phase line 54, and an N phase line 55. Ends of the cover plate 51, the cover plate 56, and each of the phase lines are located outside the ends of the side plates 57.

The two busways 50 are located on two sides of the busway connector 100 in the length direction L. When each of the busways 50 is connected to the busway connector 100, the cover plate 51 is inserted into the space 501, the A phase line 52 is inserted into the space 502, the B phase line 53 is inserted into the space 503, the C phase line 54 is inserted into the space 504, the N phase line 55 is inserted into the space 505, and the cover plate 56 is inserted into the space 506.

Specifically, referring to FIG. 10, the A phase lines 52 are electrically connected to the B phase lines 53 through the first conductor 13, the conducting members 12 and the second conductor 14 of the partition plate 10A. That is, the A phase lines and the B phase lines are connected in parallel through the partition plate 10A and then can serve as the positive phase line after being connected in parallel. The B phase line 53 and the C phase line 54 of each of the busways 50 are insulated from each other under the isolation of the partition plate 40B. The C phase lines 54 are electrically connected to the N phase lines 55 through the first conductor 13, the conducting members 12, and the second conductor 14 of the partition plate 10B. That is, the C phase lines and the N phase lines are connected in parallel through the partition plate 10B, and then can serve as the negative phase line after being connected in parallel. Therefore, the busway assembly 1000 can be directly applied to the DC application scenario.

In embodiments according to the present disclosure, by selectively providing the partition plates 10 of the busway connector 100 with the conducting members 12 that electrically connect the first conductor 13 to the second conductor 14, two adjacent phase lines of the busway can be easily connected in parallel without adding an additional component. The temperature rise of the plurality of phase lines connected in parallel through the busway connector 100 is relatively balanced, which helps improve the performance of the busway.

Various embodiments of the present disclosure have been described above, which are illustrative, not exhaustive, and are not limited to the embodiments disclosed. Many modifications and variations will be apparent to those of ordinary skill in the art without departing from the scope and spirit of the illustrated embodiments. The selection of the terms used herein is intended to best explain the principles of the embodiments, practical applications, or technical improvements in the marketplace, or to enable others of ordinary skill in the art to understand the embodiments disclosed herein.

1. A partition plate of a busway connector, comprising:
a separator body comprising a first surface and a second surface that are opposite to each other;
at least one conducting member mounted in the separator body;
a first conductor fixed on the first surface; and
a second conductor fixed on the second surface and electrically connected to the first conductor through the at least one conducting member.

2. The partition plate of claim 1, wherein the separator body is provided with at least one through hole, and the at least one conducting member is fitted in the at least one through hole.

3. The partition plate of claim 2, wherein the at least one conducting member is integrally formed with the first conductor or the second conductor.

4. The partition plate of claim 1, wherein the separator body is integrally formed with the at least one conducting member through injection molding.

5. The partition plate of claim 1, wherein the separator body is provided with a mounting hole for a fastener to pass through, and the separator body is fitted with two conducting members, and
wherein the two conducting members are arranged at an interval along a length direction of the separator body and are located on two opposite sides of the mounting hole.

6. The partition plate of claim 1, wherein
the separator body is provided with a mounting hole for a fastener to pass through, and a first sleeve part and a second sleeve part which are arranged around the mounting hole, and wherein the first sleeve part extends outwardly from the first surface, and the second sleeve part extends outwardly from the second surface; and
the first conductor has a first connecting hole sleeved on the first sleeve part, and the second conductor has a second connecting hole sleeved on the second sleeve part.

7. The partition plate of claim 6, wherein
the first connecting hole and the second connecting hole are both rectangular holes and have the same size; and/or
an end face of the first sleeve part is provided with an annular sleeve part for insertion into a sleeve part of a partition plate adjacent to the first surface, and the second sleeve part is for a sleeve part of a partition plate adjacent to the second surface to be inserted therein.

8. A busway connector, comprising:
two end caps disposed opposite to each other;
a plurality of partition plates disposed between the two end caps, at least two of the plurality of partition plates being a partition plate comprising:
a separator body comprising a first surface and a second surface that are opposite to each other;
at least one conducting member mounted in the separator body;
a first conductor fixed on the first surface; and
a second conductor fixed on the second surface and electrically connected to the first conductor through the at least one conducting member; and
a fastener assembly securing the two end caps and the plurality of partition plates together.

9. The busway connector of claim 8, wherein the separator body is provided with at least one through hole, and the at least one conducting member is fitted in the at least one through hole.

10. The busway connector of claim 9, wherein the at least one conducting member is integrally formed with the first conductor or the second conductor.

11. The busway connector of claim 8, wherein the separator body is integrally formed with the at least one conducting member through injection molding.

12. The busway connector of claim 8, wherein the separator body is provided with a mounting hole for a fastener to pass through, and the separator body is fitted with two conducting members, and
wherein the two conducting members are arranged at an interval along a length direction of the separator body and are located on two opposite sides of the mounting hole.

13. The busway connector of claim 8, wherein
the separator body is provided with a mounting hole for a fastener to pass through, and a first sleeve part and a second sleeve part which are arranged around the mounting hole, and wherein the first sleeve part extends outwardly from the first surface, and the second sleeve part extends outwardly from the second surface; and
the first conductor has a first connecting hole sleeved on the first sleeve part, and the second conductor has a second connecting hole sleeved on the second sleeve part.

14. The busway connector of claim 13, wherein
the first connecting hole and the second connecting hole are both rectangular holes and have the same size; and/or
an end face of the first sleeve part is provided with an annular sleeve part for insertion into a sleeve part of a partition plate adjacent to the first surface, and the second sleeve part is for a sleeve part of a partition plate adjacent to the second surface to be inserted therein.

15. The busway connector of claim 8, wherein the plurality of partition plates comprise a first partition plate, a second partition plate, a third partition plate, a fourth partition plate, and a fifth partition plate which are sequentially arranged, wherein the second partition plate and the fourth partition plate adopt the partition plate comprising:
the separator body comprising the first surface and the second surface that are opposite to each other;
the at least one conducting member mounted in the separator body;
the first conductor fixed on the first surface; and
the second conductor fixed on the second surface and electrically connected to the first conductor through the at least one conducting member.

16. A busway assembly, comprising:
two busways; and
a busway connector connected between the two busways, and comprising:
two end caps disposed opposite to each other;
a plurality of partition plates disposed between the two end caps, at least two of the plurality of partition plates being a partition plate comprising:
a separator body comprising a first surface and a second surface that are opposite to each other;
at least one conducting member mounted in the separator body;
a first conductor fixed on the first surface; and
a second conductor fixed on the second surface and electrically connected to the first conductor through the at least one conducting member; and
a fastener assembly securing the two end caps and the plurality of partition plates together.
